(19) United States
(12) Patent Application Publication
(10) Pub. No.: US 2015/0110361 A1
(43) Pub. Date: Apr. 23, 2015

(54) System and method for collection and validation of nutritional data

(71) Applicant: Nutritionix, LLC, Washington, DC (US)

(72) Inventors: Matthew Silverman, Evanston, IL (US); Daniel Zadoff, Miami, FL (US); James Qualls, Washington, DC (US)

(21) Appl. No.: 14/514,547

(22) Filed: Oct. 15, 2014

Related U.S. Application Data
(60) Provisional application No. 61/891,971, filed on Oct. 17, 2013.

(51) Int. Cl. G06K 9/62; G06F 17/30; G06K 9/78

(52) U.S. Cl. CPC G06K 9/6202; G06K 9/78; G06F 17/30247; G06F 17/3028
USPC 382/110

(57) ABSTRACT

A method for collection and validation of nutritional data includes capturing, by a first digital camera device, at least one first image of a first product, and transmitting the at least one first image to a server. The method includes comparing, by the server, at least one first nutritional value extracted from the at least one first image to at least one corresponding second nutritional value extracted from the at least one first image. The method includes establishing, by the server, that the at least one first nutritional value is correct. The method includes publishing, by the server, nutritional data from the at least one first image.

### RELATED APPLICATION DATA

This application claims the priority of prior U.S. provisional application Ser. No. 61/891,971 filed on Oct. 17, 2013, which is hereby incorporated by reference herein in its entirety.

### TECHNICAL FIELD

This invention relates to the capture and presentation of digital imagery. More particularly, the present invention relates to network based collection of nutritional information.

### BACKGROUND ART

Many of the issues affecting individual and public health currently concern nutrition. From metabolic syndrome sufferers trying to reduce their glycemic indices to people of all ages trying cut back on sodium or lose weight, it is increasingly common for a person who wishes to improve his or her health to find that altering the quantity and contents of food intake is essential. As more people become more conscious consumers of food, the demand for nutritional information concerning food products will increase, and the ability to compare nutritional information concerning various products will become greater. Thus, there is a need for databases that store validated nutritional data so that a user can search such a database for identifying food items that fulfill specific nutritional and/or dietary criteria, and for techniques to create such databases in a rapid, accurate, and efficient manner.

### SUMMARY OF THE EMBODIMENTS

In one aspect, a method for collection and validation of nutritional data includes capturing, by a first digital camera device, at least one first image of a first product, and transmitting the at least one first image to a server. The method includes comparing, by the server, at least one first nutritional value extracted from the at least one first image to at least one corresponding second nutritional value extracted from the at least one first image. The method includes establishing, by the server, that the at least one first nutritional value is correct. The method includes publishing, by the server, nutritional data from the at least one first image.

In a related embodiment, capturing the at least one first image further includes scanning a code affixed to the first product. In another related embodiment, capturing the at least one first image further involves capturing an image of a nutritional label. In an additional embodiment, capturing the at least one first image also includes capturing an image of an ingredient statement. In a further embodiment, comparing also involves receiving, from a first user, the at least one first nutritional value and receiving, from a second user, the at least one second nutritional value. In yet another embodiment comparing further includes extracting, by the server, at least one of the first nutritional value and the second nutritional value from the at least one first image.

In an additional related embodiment, establishing also involves determining that the at least one first nutritional value is substantially equal to the at least one second nutritional value. In another embodiment, establishing further includes calculating, by the server, that at the least one first nutritional value differs from at least one corresponding second nutritional value and determining, by the server, that the at least one first nutritional value is correct. In a related embodiment, determining also includes providing the at least one first nutritional value and the at least one second nutritional value to a user of the server and receiving, from the user, an instruction indicating that the at least one first nutritional value is correct. In another related embodiment, determining further involves receiving, from a second digital camera device, at least one second image of a second product, identifying that the second product is identical to the first product, and determining that at least one corresponding third nutritional value extracted from the at least one second image is substantially equal to the at least one first nutritional value. In another embodiment, identifying further involves extracting, from the at least one first image, a first product identifier, extracting, from the at least one second image, a second product identifier, and determining that the first product identifier matches the second product identifier. In still another embodiment, identifying also includes extracting, from the at least one first image, a first product identifier, receiving, from the second digital camera device, a second product identifier, and determining that the first product identifier matches the second product identifier. In an additional embodiment, identifying further includes extracting, from the at least one second image, a first product identifier, receiving, from the first digital camera device, a first product identifier and determining that the first product identifier matches the second product identifier. In yet another embodiment, identifying also involves receiving, from the first digital camera device, a first product identifier, receiving, from the second digital camera device, a second product identifier, and determining that the first product identifier matches the second product identifier.

In a related embodiment, determining further includes extracting an aggregate amount from the at least one first image, determining that the at least one first nutritional value is consistent with the aggregate amount, and determining that the at least one second nutritional value is not consistent with the aggregate amount. In an additional embodiment, publishing further involves storing the nutritional data in a database and providing access to the database to a user.

In another aspect, system for collection and validation of nutritional data includes a server, a first digital camera device, configured to capture at least one first image of a first product and to transmit the first image to the server, and a comparator, executing on the server, and configured to compare least one first nutritional value extracted from the at least one first image to at least one corresponding second nutritional value extracted from the at least one first image, to establish that the at least one first nutritional value is correct, and to publish nutritional data from the at least one first image. A related embodiment also includes a second digital camera device, configured to capture at least one second image of a second product and to transmit the at least one second image to the server.

These and other features of the present system and method will be presented in more detail in the following detailed description of the invention and the associated figures.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram of an embodiment of the disclosed system; and

FIG. 3 is a flow diagram illustrating one embodiment of the disclosed method.

### DETAILED DESCRIPTION OF SPECIFIC EMBODIMENTS

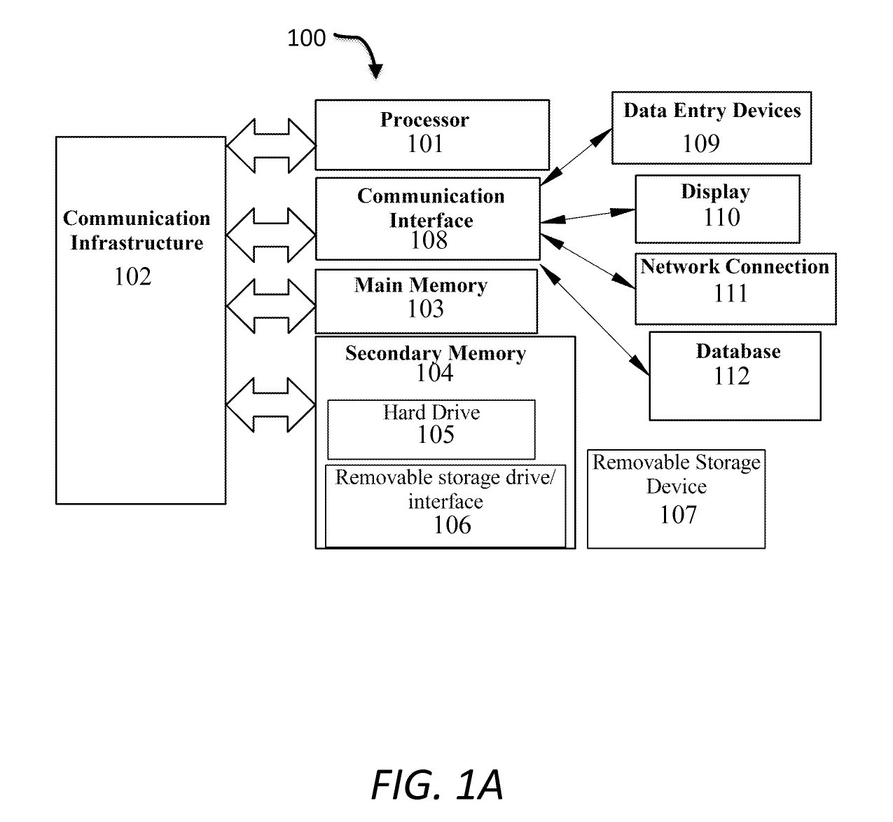

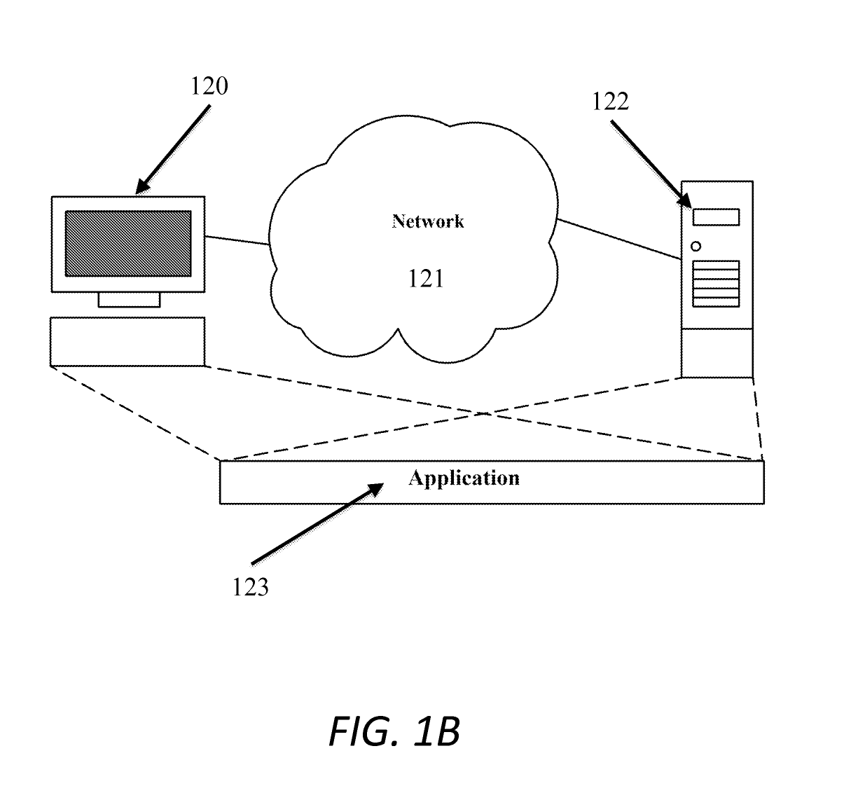

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. A code scanner coupled to a computing device is a device that can extract information from a “code” attached to an object. In one embodiment, a code contains data concerning the object to which it is attached that may be extracted automatically by a scanner; for instance, a code may be a bar code whose data may be extracted using a laser scanner. A code may include a quick-read (QR) code whose data may be extracted by a digital scanner or camera. A code may include a radio frequency identification (RFID) tag; the code may include an active RFID tag. The code may include a passive RFID tag. A computing device 100 may also be coupled to a code exporter; in an embodiment, a code exporter is a device that can put data into a code. For instance, where the code is a two-dimensional image printed on paper or another object, the code exporter may be a printer. Where the code is a non-writable RFID tag, the code exporter may be a device that can produce a non-writable RFID tag. Where the code is a writable RFID tag, the code exporter may be an RFID writer; the code exporter may also be a code scanner, in some embodiments.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods collect and publish nutritional information concerning food products quickly and efficiently through crowd-sourcing. The ubiquity of digital cameras, such as those on smartphones, makes it easy for users to share images of nutritional labels and similar descriptors of products' nutritional value. Protocols for comparing images provide a rapid and effective way to ensure that the information received is correct.

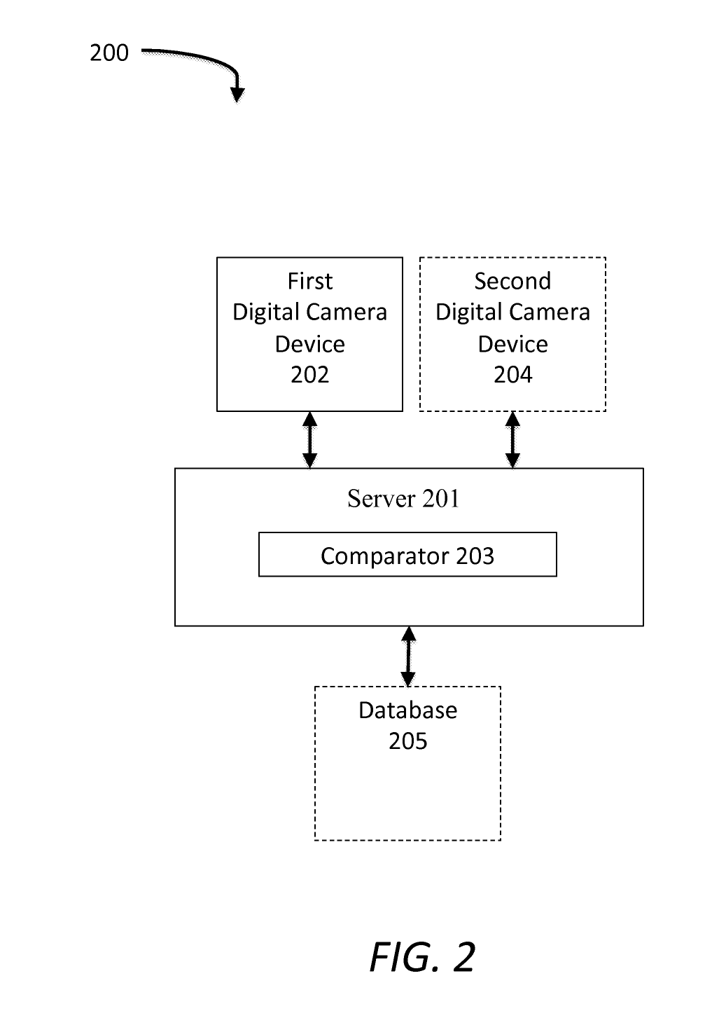

FIG. 2 illustrates an embodiment of a system 200 for collection and validation of nutritional data. As a brief overview, the system 200 includes a server 201. The system 200 includes a first digital camera device 202. Executing on the server 201 is a set of algorithmic steps that may be conceptually described as creating a comparator 203. The organization of tasks into this component solely reflects a categorization of the tasks to be performed, and does not dictate the architecture of particular implementations of the system 200. For instance, in some embodiments of the system 200, the steps performed are executed by various objects in an object-oriented language, but the objects divide the tasks in a different manner than the above categorization. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the server 201 to perform the algorithmic steps.

Referring to FIG. 2 in further detail, the system 200 includes a server 201. In some embodiments, the server 201 is a computing device 100 as disclosed above in reference to FIG. 1A. In other embodiments, the server 201 is a set of computing devices 100, as discussed above in reference to FIG. 1A, working in concert; for example, the server 201 may be a set of computing devices 100 in a parallel computing arrangement. The server 201 may be a set of computing devices 100 coordinating their efforts over a private network, such as a local network or a virtual private network (VPN). The server 201 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the server 201 is a server 122 as disclosed above in reference to FIG. 1B. The server 201 may communicate with one or more additional servers 122. The server 201 and the one or more additional servers 122 may coordinate their processing to emulate the activity of a single server 122 as described above in reference to FIG. 1B. The server 201 and the one or more additional servers 122 may divide tasks up heterogeneously between devices; for instance, the server 201 may delegate the tasks of one component to an additional server 122. In some embodiments, the server 201 functions as a client device 120 as disclosed above in reference to FIG. 1B.

The system 200 includes a first digital camera device 202. In one embodiment, the first digital camera device 202 is a device that captures images by recording a spatially differentiated pattern of electromagnetic radiation in a set of digital circuitry; the digitally recorded pattern may be saved in memory as described above in reference to FIGS. 1A-1B. The first digital camera 202 may be incorporated in a computing device; for instance, the first digital camera 202 may be the built-in digital camera of a mobile device such as a tablet or mobile phone. The first digital camera device 202 may be coupled to a computing device. As an example, the first digital camera device 202 may be in wireless or wired communication with a nearby computing device. The first digital camera device 202 may be configured to capture a first image of a first product and to transmit the first image to the server. The system 200 may include a second digital camera device 204. The second digital camera device 204 may be any device suitable for use as the first digital camera device 202. In some embodiments, the second digital camera device 204 is the same device first digital camera device 202. In other embodiments, the second digital camera device 204 is a distinct device from the first digital camera device 202. In some embodiments, the second digital camera device 204 is configured to capture a second image of a second product and to transmit the second image to the server.

The system 200 includes a comparator 203 executing on the server 201. The comparator 203 in some embodiments is a computer program as described above in reference to FIGS. 1A and 1B. In some embodiments, the comparator 203 is configured to compare least one first nutritional value extracted from the at least one first image to at least one corresponding second nutritional value extracted from the at least one first image, to establish that the at least one first nutritional value is correct, and to publish nutritional data from the at least one first image.

In some embodiments, the system 200 includes a database 205. The database 205 may be a database 112 as disclosed above in reference to FIGS. 1A-1B. The server 201 may store the at least one first image, the at least one second image, or nutritional data corresponding to the first product or the second product, in the database 205, as set forth in further detail below.

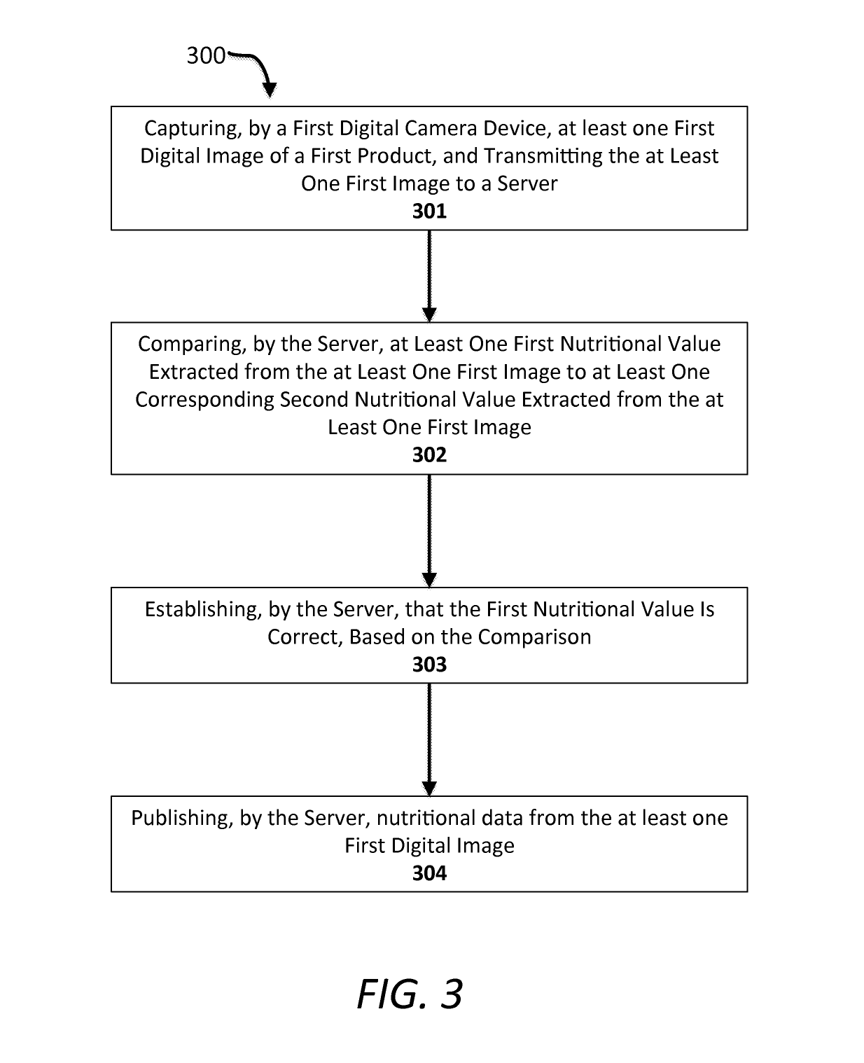

FIG. 3 illustrates some embodiments of a method 300 for collection and validation of nutritional data. The method 300 includes capturing, by a first digital camera device, at least one first image of a first product, and transmitting the at least one first image to a server (301). The method 300 includes comparing, by the server, at least one first nutritional value extracted from the at least one first image to at least one corresponding second nutritional value extracted from the at least one first image (302). The method 300 includes establishing, by the server, that the at least one first nutritional value is correct (303). The method 300 includes publishing, by the server, nutritional data from the at least one first image (304).

Referring to FIG. 3 in greater detail, and by reference to FIG. 2, method 300 includes capturing, by a first digital camera device, at least one first image of a first product, and transmitting the first image to a server (301). In some embodiments, the at least one first image includes an image of a nutritional label associated with the first product; the label may be affixed to the first product, or displayed nearby to the first product. The label may share a product identifier, as described below, with the first product. In some embodiments, the at least one first image includes an image of the packaging of the first product. In other embodiments, the at least one first image includes an image of a code associated with the first product. The at least one first image may include a product identifier; the product identifier may be a name of a product. The product identifier may be a number identifying the product, such as a stock-keeping unit (SKU). The at least one first image may be a single image. The at least one first image may be two or more images. As an example, the user of the first digital camera device may capture an image of a nutritional label on the back of the first product, and of the logo and product name on the front of the product. In some embodiments, capturing the at least one first image further includes scanning a code, as described above in reference to FIGS. 1A-1B, that is affixed to the product. The first digital camera device 202 may capture an image of an ingredient statement. In some embodiments, the first digital camera device 202 captures a set of images; for instance, the first digital camera device 202 may scan a code, such as a bar code or QR code, a nutrition label, the front of the product, and the ingredient statement. In some embodiments, the at least one first image of the first product includes one or more images taken by a second digital camera device 204 as described above.

The method 300 includes comparing, by the server, at least one first nutritional value extracted from the at least one first image to at least one corresponding second nutritional value extracted from the at least one first image (302). In one embodiment, the at least one second nutritional value corresponds to the at least one first nutritional value if the at least one second nutritional value includes at least one nutritional value in common with the at least one first nutritional value. For instance, the at least one first nutritional value may be a single value such as the total calories from fat listed for the first product, and the at least one second nutritional value may be a set of values taken from the nutrition label of the first product, and including the total calories from fat. Likewise, the at least one first nutritional value may be a partial or complete list of values from the nutritional label, and the second nutritional value may be a partial or complete list of values from the nutritional label, where at least one item on the second list is also on the first list. The comparator 203 may determine that the at least one second nutritional value corresponds to the at least one first nutritional value by determining that each value describes the same quantity; for instance, the at least one first nutritional value might come from a line in a nutritional label saying “Total fat—7 g,” and the at least one corresponding second nutritional value may also come from a line bearing the words “Total fat” and a quantity, indicating that the quantities correspond to one another, and can be directly compared.

In some embodiments, the comparator 203 receives, from a first user, the at least one first nutritional value and receives, from a second user, the at least one second nutritional value. As an example, the first user may view the at least one first image and enter the at least one first nutritional value by reading the at least one first nutritional value from the at least one first image and entering the value using manual data entry means as described above in reference to FIGS. 1A-1B; the manual data entry means may be coupled to a computing device, such as a workstation or mobile device, that is in contact with the server 201. The comparator 203 may present the image via a web page displaying on the user's computing device. The comparator 203 may present the image via a mobile application running on the user's computing device. In some embodiments, the first user enters data via form displayed on the web page or on the mobile application. The second user may enter the at least one second nutritional value in a similar fashion.

In another embodiment, the comparator 203 extracts at least one of the at least one first nutritional value and the at least one second nutritional value from the at least one first image. The comparator 203 may extract the at least one value using optical character recognition (OCR) software. The comparator 203 may receive the at least one value from another computing device (not shown) that contains OCR software. The comparator 203 may extract other information from the at least one first image as well; for instance, the comparator 203 may extract at least one ingredient from the ingredient statement. The at least one first nutritional value may be extracted from the nutritional label. The at least one first nutritional value may be extracted from the ingredient statement. The comparator 203 may extract the at least one corresponding second nutritional value from the at least one second image, using any process as described above for extracting the at least one first nutritional value. The comparator 203 may receive the at least one first nutritional value from the first digital camera device 202. The comparator 203 may receive the at least one corresponding second nutritional value from the second digital camera device 204.

The method 300 includes establishing, by the server, that the at least one first nutritional value is correct (303). In some embodiments, the comparator 203 determines that the at least one first nutritional value is substantially equal to the at least one second nutritional value. The at least one first nutritional value may be substantially equal to the at least one second nutritional value if the two values are exactly equal. The two values may be substantially equal if they are equal to a specified level of precision; for instance if one value is in grams and the other is a percentage of a certain overall number of grams, and the percentage would result in a decimal representation of multiple significant figures, a value in grams that abbreviates that representation to a whole number or to one or two decimal places may be considered equivalent to the percentage. Likewise, if one quantity has more significant figures than the other quantity, and the other quantity is equivalent to a possible rounded version of the first quantity, the two quantities may be substantially equal.

In other embodiments, the comparator 203 calculates that the at least one first nutritional value differs from the at least one corresponding second nutritional value and determines that the at least one first nutritional value is correct. In one embodiment, the comparator 203 calculates that two values are not equivalent by determining that the two values are not substantially equal. In some embodiments, the comparator 203 determines that the at least one first nutritional value is correct by providing the at least one first nutritional value and at least one second nutritional value to a user of the server and receiving, from the user, an instruction indicating that the at least one first nutritional value is correct. The comparator 203 may provide the two values to the user by means of a client device in the user's possession, such as a computer workstation or mobile device. The comparator 203 may also provide the at least one first image to the user; the user may perceive a way to determine which image is likely to contain the correct nutritional value by intuitive or holistic reasoning means beyond the capability of the comparator 203. The comparator 203 may seek user input if other tests to determine the correct value do not succeed.

The comparator 203 may determine that the at least one first nutritional value is correct by receiving, from a second digital camera device 204, at least one second digital image of a second nutritional label affixed to a second product, identifying that the second product is identical to the first product, and determining that at least one corresponding third nutritional value extracted from the at least one second digital image is substantially equal to the at least one first nutritional value. As an example, users interested in participating in the collection of nutritional data for the system 200 may periodically capture images containing nutritional information, including images of the product in question, and transmit those images to the server 201; the server 201 may save the at least one first image until a second image of the same product arrives, and then compare the at least one third nutritional value to the at least one first value and the at least one second value. The at least one third nutritional value may function as a “tie-breaker”; for instance, if it matches the at least one first nutritional value, the comparator 203 may determine, based on that match, that the at least one first nutritional value is the correct one.

In some embodiments, the comparator 203 determines that the second product is the same as the first product by extracting, from the at least one first image, a first product identifier, extracting, from the at least one second image, a second product identifier, and determines that the first product identifier matches the second product identifier. The comparator 203 may extract the textual data from images using an OCR algorithm. In other embodiments, the comparator 203 extracts textual data from an image by presenting the image to a user, and receiving, from the user, textual data describing the product identifiers. The comparator 203 may present the image to a user by means of a computing device used by the user. The computing device may be the first digital camera device 202, or a computing device coupled to the first digital camera device 202. The computing device may be the second digital camera device 204, or a computing device coupled to the second digital camera device 204. The comparator 203 may determine that the first product identifier is exactly the same as the second product identifier. The comparator 203 may determine that the first product identifier is substantially the same as the second product identifier. The comparator 203 may determine that the first product identifier is linked to the second product identifier; for instance, the first product identifier may be the name of a product, and the second product identifier may be the SKU of the same product. In other embodiments, the comparator 203 determines that at least one ingredient from an ingredient statement included in the first digital image is the same as at least one ingredient from an ingredient statement included in the second digital image.

In other embodiments, the comparator 203 extracts the first product identifier from the at least one first image, receives, from the second digital camera device, a second product identifier, and determines that the first product identifier matches the second product identifier. The second digital camera device 204 may extract the second product identifier from the at least one second image, as described above. The second digital camera device 204 may extract the second product identifier from a code using a code scanner coupled to the second digital camera device 204. A user of the second product identifier may enter text describing the product identifier into the second digital camera, for instance by reading the information off of the second product. In other embodiments, the comparator 203 extracts the second product identifier from the at least one second image, receives, from the first digital camera device, a first product identifier, and determines that the first product identifier matches the second product identifier. In still other embodiments, the comparator 203 receives, from the first digital camera device, a first product identifier, receives, from the second digital camera device, a second product identifier, and determines that the first product identifier matches the second product identifier.

In other embodiments, the comparator 203 determines that the at least one first nutritional amount is correct by extracting an aggregate amount from the at least one first image, determining that the at least one first nutritional value is consistent with the aggregate amount, and determining that the at least one second nutritional value is not consistent with the aggregate amount. As an example, a nutritional label may present nutritional values according to broad categories, and then list subcategories under some of the broad categories; for instance, the label may list one number for “total carbohydrates,” and another for “total sugars,” starches, fructose, or other specific forms of carbohydrates. Continuing the example, the comparator 203 may combine the numbers presented by the subcategories and compare the number thus obtained to the main category quantity, for instance by adding together total sugars and starches and comparing that number to the total carbohydrates; if the at least one first nutritional amount is consistent with the aggregate amount, and the at least one second nutritional amount is not consistent with the aggregate amount, then the comparator 203 may determine that the first nutritional value is correct.

The method 300 includes publishing, by the server, nutritional data from the at least one first image (304). In some embodiments, the server 201 stores the at least one first image in a database 205; the database 205 may be a database 112 as described above in reference to FIGS. 1A-1B. Any of the images may be manipulated prior to storing in a database 205. For example the images may be cropped, rotated, or enhanced by adjusting brightness, contrast, and/or sharpness of the images. The database 205 may contain further information linked to the at least one first image; for example, the database 205 may link the at least one first image to one or more product identifiers. The database 205 may link the at least one first image to one or more product categories; one product category may describe a particular kind of food product, such as yogurt blended with fruit, while another product category may describe a broader category, such as yogurt or dairy, encompassing many kinds of related products. The database 205 may link the at least one first image with one or more nutrition facts; for instance, the database 205 may describe the amount of dietary fiber per serving of the first product. The database 205 may link the at least one first image with one or more flavors or ingredients. The server 201 may store any of the above data in any other data structure instead of a database.

The server 201 may make the database 205 available to users via a web page. In other embodiments, the server 201 makes the database 205 available to users using an application the users operate on additional computing devices. The application may be a mobile application. In some embodiments, the user may enter a query via the website or application; the query may include a product identifier. The query may include a product category. The query may include one or more nutritional values; for instance the user may need a certain amount of dietary fiber per serving of food, and may enter a query requesting that amount of dietary fiber. The query may include ranges of nutritional values, such as 3 grams or less of saturated fat, or 5 grams or more of dietary fiber, per serving. The query may combine several of the elements described above; for instance, the user may enter a query requesting a sweetened yogurt containing strawberries, having less than 2 grams of fat, less than 4 grams of carbohydrates, and more than 5 grams of insoluble fiber. The server 201 may respond to the query with one or more products matching the query. The server 201 may respond to the query with the at least one first image. The server 201 may present any set of data that is linked in the database 205 in response to the query.

Although the foregoing systems and methods have been described in some detail for purposes of clarity of understanding, it will be apparent that certain changes and modifications may be practiced within the scope of the appended claims.

What is claimed is:

1. A method for collection and validation of nutritional data, the method comprising:
capturing, by a first digital camera device, at least one first image of a first product, and transmitting the at least one first image to a server;
comparing, by the server, at least one first nutritional value extracted from the at least one first image to at least one corresponding second nutritional value extracted from the at least one first image;
establishing, by the server, that the at least one first nutritional value is correct; and
publishing, by the server, nutritional data from the at least one first image.

2. A method according to claim 1, wherein capturing the at least one first image further comprises scanning a code affixed to the first product.

3. A method according to claim 1, wherein capturing the at least one first image further comprises capturing an image of a nutritional label.

4. A method according to claim 1, wherein capturing the at least one first image further comprises capturing an image of an ingredient statement.

5. A method according to claim 1, wherein comparing further comprises:
receiving, from a first user, the at least one first nutritional value; and
receiving, from a second user, the at least one second nutritional value.

6. A method according to claim 1, wherein comparing further comprises extracting, by the server, at least one of the first nutritional value and the second nutritional value from the at least one first image.

7. A method according to claim 1, wherein establishing further comprises determining that the at least one first nutritional value is substantially equal to the at least one second nutritional value.

8. A method according to claim 1, wherein establishing further comprises:
calculating, by the server, that at the least one first nutritional value differs from at least one corresponding second nutritional value; and
determining, by the server, that the at least one first nutritional value is correct.

9. A method according to claim 8, wherein determining further comprises:
providing the at least one first nutritional value and the at least one second nutritional value to a user of the server; and
receiving, from the user, an instruction indicating that the at least one first nutritional value is correct.

10. A method according to claim 8, wherein determining further comprises:
receiving, from a second digital camera device, at least one second image of a second product;
identifying that the second product is identical to the first product; and
determining that at least one corresponding third nutritional value extracted from the at least one second image is substantially equal to the at least one first nutritional value.

11. A method according to claim 10, wherein identifying further comprises:
extracting, from the at least one first image, a first product identifier;
extracting, from the at least one second image, a second product identifier; and
determining that the first product identifier matches the second product identifier.

12. A method according to claim 10, wherein identifying further comprises:
extracting, from the at least one first image, a first product identifier;
receiving, from the second digital camera device, a second product identifier; and
determining that the first product identifier matches the second product identifier.

13. A method according to claim 10, wherein identifying further comprises:
receiving, from the first digital camera device, a first product identifier;
extracting, from the at least one second image, a second product identifier; and
determining that the first product identifier matches the second product identifier.

14. A method according to claim 10, wherein identifying further comprises:
receiving, from the first digital camera device, a first product identifier;
receiving, from the second digital camera device, a second product identifier; and
determining that the first product identifier matches the second product identifier.

15. A method according to claim 1, wherein determining further comprises:
extracting an aggregate amount from the at least one first image;
determining that the at least one first nutritional value is consistent with the aggregate amount; and
determining that the at least one second nutritional value is not consistent with the aggregate amount.

16. A method according to claim 1, wherein publishing further comprises:
storing the nutritional data in a database; and
providing access to the database to a user.

17. A system for collection and validation of nutritional data, the system comprising:
a server;
a first digital camera device, configured to capture at least one first image of a first product and to transmit the first image to the server; and
a comparator, executing on the server, and configured to compare least one first nutritional value extracted from the at least one first image to at least one corresponding second nutritional value extracted from the at least one first image, to establish that the at least one first nutritional value is correct, and to publish nutritional data from the at least one first image.

18. A system according to claim 16, further comprising a second digital camera device, configured to capture at least one second image of a second product and to transmit the at least one second image to the server.
